(19) United States
(12) Patent Application Publication
(10) Pub. No.: US 2003/0181294 A1
(43) Pub. Date: Sep. 25, 2003

(54) Shoe assembly for leg healthful exercise

(76) Inventor: Tien-Sung Hou, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/100,123

(22) Filed: Mar. 19, 2002

(51) Int. Cl. A63B 22/00; A63B 71/00; A61H 3/04

(52) U.S. Cl. 482/68; 482/51

(57) ABSTRACT

A shoe assembly for leg healthful exercise is composed by a shoe base and at least one rolling wheel. The shoe base is provided with a fastening strip at one side, and at least one screw hole is provided in the quarter portion of the shoe base. The rolling wheel has a central hole, and at least one -shape pivotal block is provided to assemble the shoe base with the rolling wheel. Both sides of the pivotal block are respectively provided with a hole, and a screwing section is provided on the top of the pivotal block. After being assembled, the shoe assembly can be worn by a user to take rightward and leftward leg exercise for health.

### BACKGROUND OF THE INVENTION

1. Field of the Invention

The present invention relates to a shoe assembly for leg healthful exercise. The present invention relates, more particularly, to a shoe assembly which is provided with at least one rolling wheel beneath the ankle portion of a shoe base in order for a user to take rightward and leftward leg exercise for health.

2. Description of the Related Art

As people today place more value on leisure exercise, various kinds of healthful exercisers have been invented, and there are so many kinds of healthful exercisers in the market, such as electric and mechanical types. Conventional healthful exercisers are bulky because of their complicated structures and designs, and they always must be placed on base frames on the ground or at the exercising places. Conventional healthful exercisers are bulky so that common consumers do not have much desire to purchase those healthful exercisers which occupy much space.

Furthermore, common people walk with feet as well as legs moving forward or backward. Their feet and legs are lack of rightward and leftward movement and cannot obtain the balanced development. Therefore, people will easily feel unwell. At present, there is no healthful exerciser for leg rightward and leftward exercise.

### SUMMARY OF THE INVENTION

Accordingly, the present invention is directed to a shoe assembly for leg healthful exercise that can substantially obviate the drawbacks of conventional healthful exercisers.

An object of the present invention is to provide a shoe assembly which is provided with at least one rolling wheel beneath the ankle portion of a shoe base in order for a user to take rightward and leftward leg exercise for health.

Another object of the present invention is to provide a shoe assembly for leg healthful exercise which is not only light and handy, convenient and easy to be operated or stored but also saves cost.

Yet another object of the present invention is to provide a shoe assembly whose at least one rolling wheel is provided beneath the ankle portion of a shoe base so as to suit for various sizes of shoes of different users, and which is even suitable for barefoot users.

To achieve these advantages, a shoe assembly for leg healthful exercise in the present invention is composed by a shoe base and at least one rolling wheel. The shoe base is provided with a fastening strip at one side, and at least one screw hole is provided in the quarter portion of the shoe base. The at least one rolling wheel has a central hole, and at least one -shape pivotal block is provided to assemble the shoe base with the at least one rolling wheel. Both sides of the at least one -shape pivotal block are respectively provided with a hole, and a screwing section is provided on the top of the at least one -shape pivotal block. After being assembled, the shoe assembly can be worn to take rightward and leftward leg exercise for health.

### BRIEF DESCRIPTION OF THE DRAWINGS

Other features and advantages of the present invention will become apparent in the following detailed description of the preferred embodiments with reference to the accompanying drawings, in which :2

FIG. 1 is a perspective exploded view of an embodiment of a shoe assembly in accordance with the present invention;

FIG. 2 is a perspective view of an embodiment of the shoe assembly in an assembled configuration in accordance with the present invention;

FIG. 3 is a side-sectional view of an embodiment of the shoe assembly in an assembled configuration while being worn by a wearer in accordance with the present invention;

FIG. 4 is a perspective schematic view of a pair of the shoe assembly in accordance with the present invention being operated by a wearer for exercise;

FIG. 5 is a perspective exploded view of an embodiment of the shoe assembly with another assembled method in accordance with the present invention; and,

FIG. 6 is a perspective exploded view of an embodiment of a sports shoe assembly in accordance with the present invention.

### DETAILED DESCRIPTION OF THE PREFERRED

Referring to FIG. 1, a preferred embodiment of a shoe assembly for leg healthful exercise in the present invention is composed by a shoe base 1 and at least one rolling wheel 2. The shoe base 1 is provided with a fastening strip 11 at one side, and at least one screw hole 12 or another assembling skill is provided in the quarter portion of the shoe base 1. The at least one rolling wheel 2 has a central hole 21, and at least one -shape pivotal block 22 is provided to assemble the shoe base 1 with the at least one rolling wheel 2. Both sides of the at least one -shape pivotal block 22 are respectively provided with a hole 23, and a screwing section 24 or another assembling skill is provided on the top of the at least one -shape pivotal block 22.

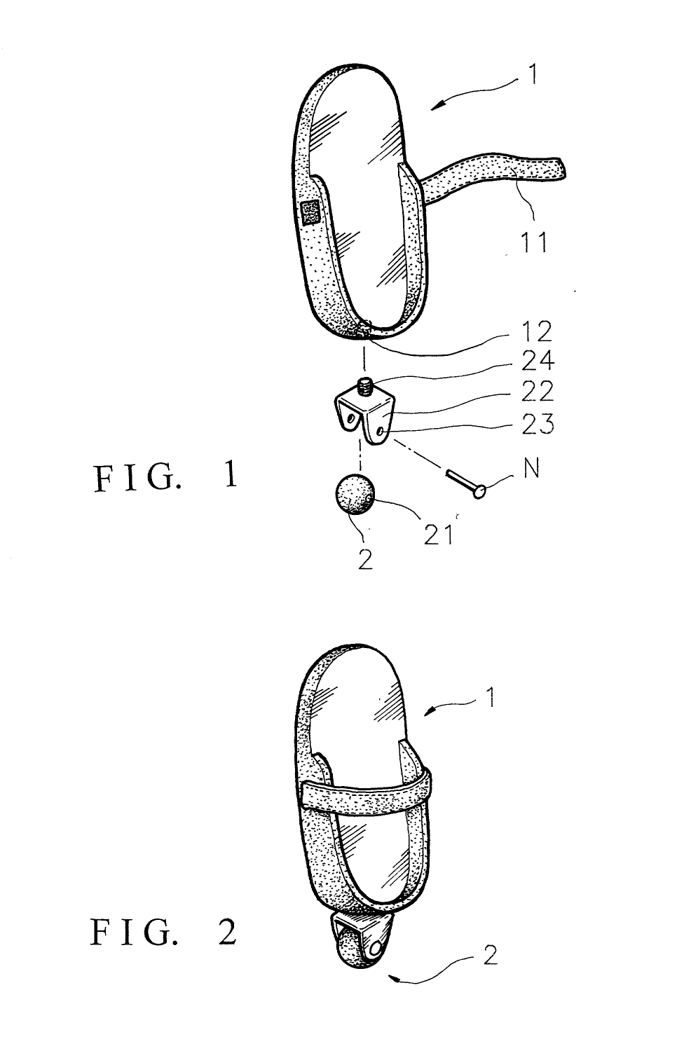

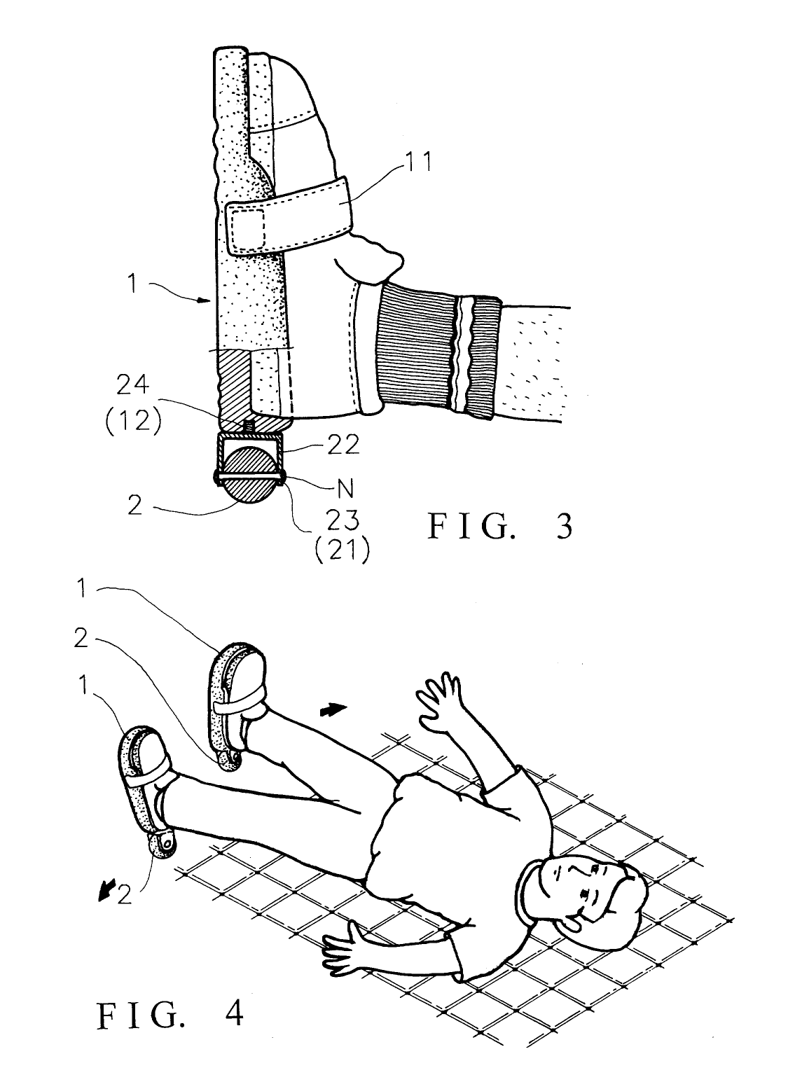

While being assembled, referring to FIGS. 2 and 3, both holes 23 are registered with the central hole 21 of the rolling wheel 2, the holes 23 as well as the central hole are penetrated by a screw or a rivet N so as to pivotally secure the rolling wheel 2 in the pivotal block 22, and then the screwing section 24 is firmly screwed in the screw hole 12 of the quarter portion of the shoe base 1.

The assembling skills in accordance with the present invention may be attractive or cohering. When being assembled by means of magnets, a strong magnet 22A is provided in the top of the -shape pivotal block 22 instead of the screwing section 24, and a strong magnet 12A is provided in the quarter portion of the shoe base 1, as shown in FIG. 5. When being assembled by means of cohesion, a layer of glue or other adhering material is respectively applied on the top of the -shape pivotal block 22 and the quarter portion of the shoe base 1.

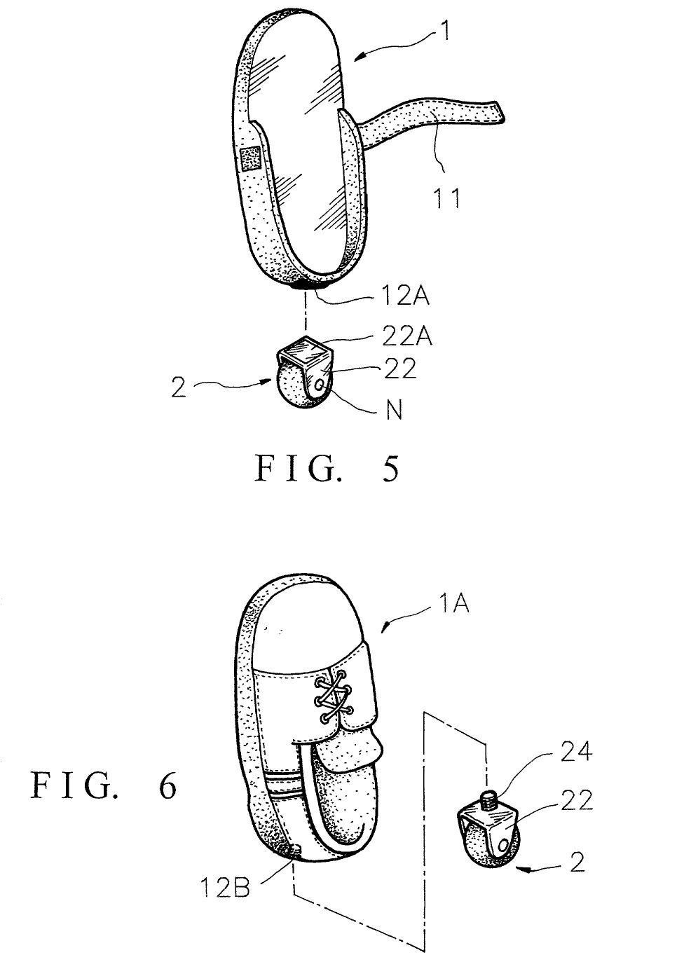

Referring to FIG. 6, a screw hole 12B can be directly provided in the quarter of a conventional sports shoe 1A so so as to be screwed up by the screwing section 24 of the -shape pivotal block 22 as well as the rolling wheel 2.

While being operated, referring to FIG. 4, a user puts on a pair of the shoe assembly with shoes or barefoot and then fastens up the fastening strips 11. Alternatively, the user can put on a pair of the sports shoe assembly. After the user lies down on a plane place, such as floor, to let the pair of shoe assembly stand upward, both rolling wheels 2 will touch the plane place. Therefore, the user can start taking exercise with his/her feet and legs sliding rightward or leftward for health.

While the preferred embodiments of the invention have been described above, it will be recognized and understood that various modifications may be made thereto, and the appended claims are intended to cover all such modifications which may fall within the spirit and scope of the invention.

What is claimed is:

1. A shoe assembly for leg healthful exercise comprising
a shoe base being provided with a fastening strip at one side,
at least one screw hole being provided in the quarter portion of said shoe base; and,
at least one rolling wheel being provided with a central hole,
at least one -shape pivotal block being provided to assemble said shoe base with said rolling wheel, both sides of said pivotal block being respectively provided with a hole, a screwing section being provided on the top of said pivotal block, a screw or a rivet being provided to penetrated through said holes of said pivotal block and said central hole of said rolling wheel so as to pivotally secure said rolling wheel in said pivotal block, and said screwing section being firmly screwed in said screw hole of the quarter portion of said shoe base.

2. A shoe assembly for leg healthful exercise as recited in claim 1, wherein a screw hole can be directly provided in the quarter of a conventional sports shoe instead of said shoe base, and wherein said screw hole of said sports shoe can be screwed up by said screwing section of said pivotal block as well as said rolling wheel.

3. A shoe assembly for leg healthful exercise as recited in claim 2, wherein the quarter portion of said shoe base can be provided with at least one strong magnet or adhering material instead of said screw hole, and wherein the top of said pivotal block can be provided with at least one strong magnet or adhering material instead of said screwing section.
